(19) United States
(12) Patent Application Publication
(10) Pub. No.: US 2011/0086713 A1
(43) Pub. Date: Apr. 14, 2011

(54) GAME DEVICE

(75) Inventors: Takeo Yoshimura, Tokyo (JP); Takeshi Niimura, Kanagawa (JP); Yusuke Yoshida, Kanagawa (JP)

(73) Assignees: TOMY COMPANY, LTD., TOKYO (JP); AQ INTERACTIVE INC., TOKYO (JP)

(21) Appl. No.: 12/448,598

(22) PCT Filed: Dec. 27, 2007
(86) PCT No.: PCT/JP2007/075127

§ 371 Date: Dec. 22, 2010

(30) Foreign Application Priority Data
Dec. 28, 2006 (JP) 2006-356007

(51) Int. Cl. A63F 13/00

(52) U.S. Cl. 463/43

(57) ABSTRACT

Disclosed is a game apparatus, including: a figurative object having a character identifying information; a reading section for reading a character information; a field section for freely moving the figurative object; a storage section for storing a plurality of display character identifying information; an identifying information reading section for reading the character identifying information from the figurative object at the reading section; a position reading section for reading position of the figurative object on the field; a display for displaying a character; and a controller for controlling the position of the character on the display, wherein when the figurative object is put on the field at a first time after the character identifying information has read by the identifying information reading section, the controller causes the display to display the character corresponding to the read character identifying information and controls the position of the character based on a read result of the position of the figurative object on the position reading section.

### TECHNICAL FIELD

The present invention relates to a game apparatus.

### BACKGROUND ART

Heretofore, a game apparatus is known which reads card data included in a card when the card is put on a field and displays on a display screen an image corresponding to the card data (see, for example, Patent Document 1). The game apparatus reads an orientation of the card from a reference marker pattern data included in a figurative object and displays on the display screen an image corresponding to the orientation.
Patent Document 1: Japanese Patent Application Laid-open Publication No. 2004-41740

### DISCLOSURE OF THE INVENTION

### Problem to be Solved by the Invention

However, the game apparatus is unadaptable to such a game apparatus that moves a character on the display screen to follow the figurative object moving on the field setting aside a case, in which the game apparatus judges only a set position of the figurative object such as a card on the field. That is, in the case that the game apparatus detects displaced position of the figurative object on the field, a problem may arises that a reader grows in size because the reader needs to read the data at every displaced positions. Moreover, another problem arises that it takes long time to read or analyze the data.

It is, therefore, a main object of the present invention to provide a simple game apparatus which can produce on a display screen a character corresponding to a character information included in the figurative object and can move the character on the display screen following the movement of the figurative object.

### Means for Solving the Problem

According to an invention described in claim 1, there is provided a game apparatus including: a figurative object having a character identifying information; a reading section for reading a character information; a field section for freely moving the figurative object; a storage section for storing a plurality of display character identifying information; an identifying information reading section for reading the character identifying information from the figurative object at the reading section; a position reading section for reading position of the figurative object on the field; a display for displaying a character; and a controller for controlling the position of the character on the display, wherein when the figurative object is put on the field at a first time after the character identifying information has read by the identifying information reading section, the controller causes the display to display the character corresponding to the read character identifying information and controls the position of the character based on a read result of the position of the figurative object on the position reading section. Here, the “figurative object” is a material object of whatever kind as long as which can be operated on the field by a player.

According to an invention described in claim 2, there is provided a game apparatus according to claim 1, wherein the figurative object includes a dot code as the character identifying information.

According to an invention described in claim 3, there is provided a game apparatus according to claim 1 or 2, wherein the identifying information reading section is composed of an optical reader.

According to an invention descried in claim 4, there is provided a game apparatus according to any one of claims 1 to 3, wherein the figurative object includes a metal section; and the figurative object position reading section includes a coil positioned under the field and detects the position of the figurative object based on an electromotive change produced at the coil according to movement of the figurative object. Here, the figurative object may include a magnet as substitute for the metal section. The point is that the figurative object should include something which already producing magnetic field or something which can produce magnetic field when put in a magnetic field.

### ADVANTAGEOUS EFFECTS OF INVENTION

According to the present invention, while characters corresponding to the character identifying information, respectively, is displayed on the display screen when the figurative object is put on the field at a first time after the character identifying information has read, the position of the character is controlled by detecting change of position of the figurative object. Therefore, a simple game apparatus can be realized.

Moreover, since the character information is read at the beginning of the game, and all the controller has to do is to monitor the position information of the figurative object during the game, process can be reduced compared with a method for reading both the identifying information and the position information successively.

Furthermore, if trying to read complicated code by a method using camera to take a picture of the field entirely, a high-speed central processing unit (CPU) or the like is needed. However, according to the present invention, a reading section for reading the character information becomes reduced in size and the complicated code (small code which is invisible to the naked eye) can be read easily, because the character information is read at only the beginning of the game.

Moreover, if only the character information once be read, reversing the figurative object is of no matter. Therefore, a new technique can be created and manners of playing the game can be expanded.

Furthermore, for example, if reversing the figurative object (for example, a tip) with being careful not to be lost by the position reading section when moving the figurative object on the field, kinds of the figurative objects are not discernible to the eye (for example, with a picture of the character down). Therefore, a new excitement of the game can be brought out when fighting in a two-player mode or the like.

### BRIEF DESCRIPTION OF THE DRAWINGS

FIG. 1 is an external view of a game apparatus according to a present invention;

FIG. 2 is a sectional view of a tip used for the game apparatus according to the present invention;

FIG. 3 is a schematic view showing a main section of an identification information reader of the game apparatus according to the present invention;

FIG. 4 is a plan view showing positional relationship of a position reader of the game apparatus according to the present invention;

FIG. 5 is a control block diagram of the game apparatus according to the present invention;

FIG. 6 is flowchart showing a character entry processing flow of the game apparatus according to the present invention;

FIG. 7 is a flowchart showing a game motion control of the game apparatus according to the present invention;

FIG. 8 is a flowchart showing a movement control of a character of the game apparatus according to the present invention;

FIG. 9 is a flowchart showing an action control of a player character according to the present invention;

FIG. 10 is an explanatory drawing showing a structure of a display screen of the game apparatus according to the present invention and a motion example of the player character;

FIG. 11 is an explanatory drawing showing a structure of a display screen of the game apparatus according to the present invention and a motion example of the player character;

FIG. 12 is an explanatory drawing showing an example of an offense pattern of the game apparatus according to the present invention; and

FIG. 13 is an explanatory drawing showing an example of a defense pattern of the game apparatus according to the present invention.

### DESCRIPTION OF THE PREFERRED EMBODIMENTS

The best mode for carrying out the invention will be described hereinbelow.

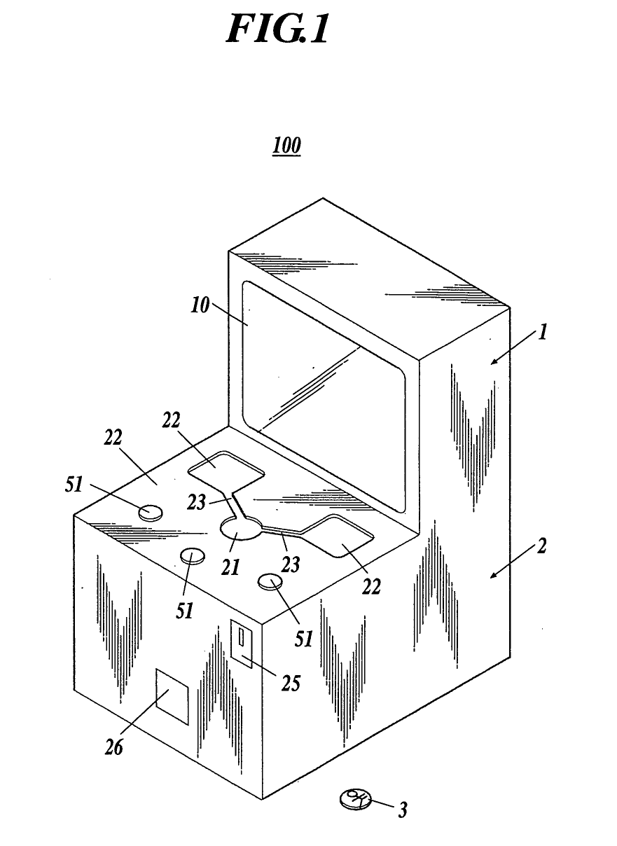

FIG. 1 shows an external view of a game apparatus 100 according to an embodiment of the present invention. As shown in FIG. 1, the game apparatus 100 is composed of an upper structure 1 and a lower structure 2. The upper structure 1 is set up in a backward position on an upper surface of the lower structure 2. A forepart of the upper surface of the lower structure 2 constitutes a table 20. A discoid tip (figurative object) 3 may be used during a game of the game apparatus 100 is goes on. Incidentally, the tip 3 in FIG. 1 is drawn to be larger than its real size relative to the game apparatus 100.

A display screen 10 is provided in a front surface of the upper structure 1. A liquid crystal display or a display screen of a well-known display apparatus may be used as the display screen 10.

A circular concave portion (reader) 21 for putting the tip 3 thereon is formed at a front center position of the table 20. A bottom plate of the concave portion 21 is composed of a transparency material. Moreover, concave portions 22 in the form of square-shaped or rectangular-shaped are formed in right and left portions of a backward portion of the table 20, respectively, wherein corners of the concave portions 22 are rounded. Each of the concave portions 22 constitutes a field for freely moving the tip 3. Moreover, band-like concave portions 23 for mutually connecting the concave portion 21 and each of the concave portions 22 are formed on the table 20.

Moreover, provided inside the lower structure 2 are a coin sorting apparatus (not shown) for sorting coins which are dropped in from a coin slot 25 after judging whether each of the dropped coins is a legitimate coin or not and a tip paying apparatus (not shown) for paying out a predetermined number of tips 3 (for example, one tip) when a predetermined coin is dropped in the slot 25. Here, in FIG. 1, a numeral 26 points a tip paying opening.

Next, main sections of the present embodiment will be described in detail.

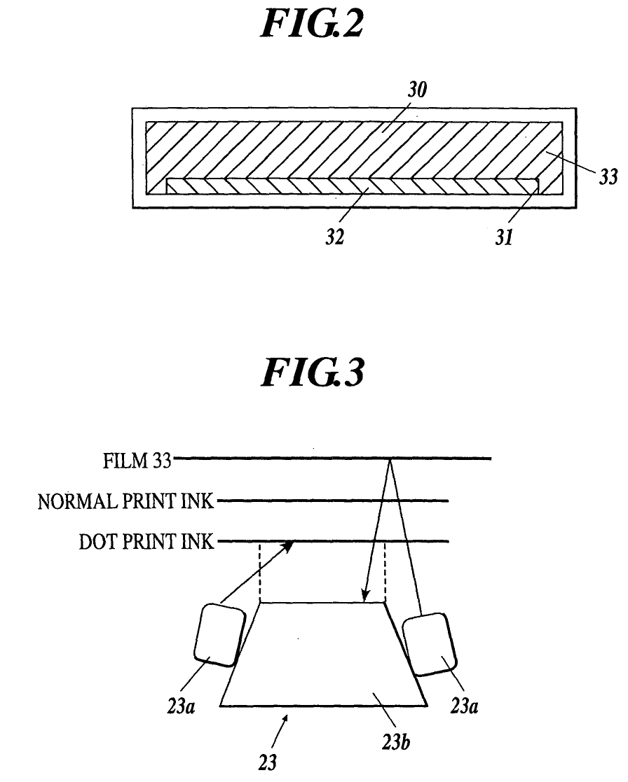

First of all, a structure of the tip 3 will be explained. As shown in FIG. 2, the tip 3 includes a plastic circular plate 30 as a substrate. A circular concave portion 31 is formed in a back side of the circular plate 30, and a piece of metal 32 is fit into the concave portion 31. Then, the circular plate 30 and the piece of metal 32 are totally covered with a film 33. Presented at a top of the tip 3 and a back surface thereof are character pictures or the like. Moreover, a dot code is presented in the back surface of the tip 3. If there is an overlapped portion between the character pictures or the like and the dot code, when printing in this case, an infrared-transparent ink is used for printing the character pictures while an infrared-absorbing ink is used for printing the dot code.

The dot code is a code invisible to the naked eye. A barcode (including two-dimensional barcode) or a mark that are visible to the naked eye may be used alternative to the dot code. However, an invisible mark such as the dot code is preferable to prevent from being shammed.

Presented inside the lower structure 3 is an optical identification information reading apparatus 23, which is positioned under the concave portion 21. FIG. 3 schematically shows a main section of the identification information reading apparatus 23. The identification information reading apparatus 23 is to be configured pen-shaped in its entirety. The identification information reading apparatus 23 includes an infrared LED 23a and a C-MOS camera 23b.

Here, a principle of reading by the identification information reading apparatus 23 will be described. An infrared ray exited from the infrared LED 23a is absorbed by a dot printing ink, while it goes through a normal printing ink. Then, the infrared ray having passed through the normal printing ink is reflected by the film 33 and received by the C-MOS camera 23b. Incidentally, a photoelectric conversion element such as, for example, a charge-coupled device (CCD) or the like may be used other than the C-MOS camera.

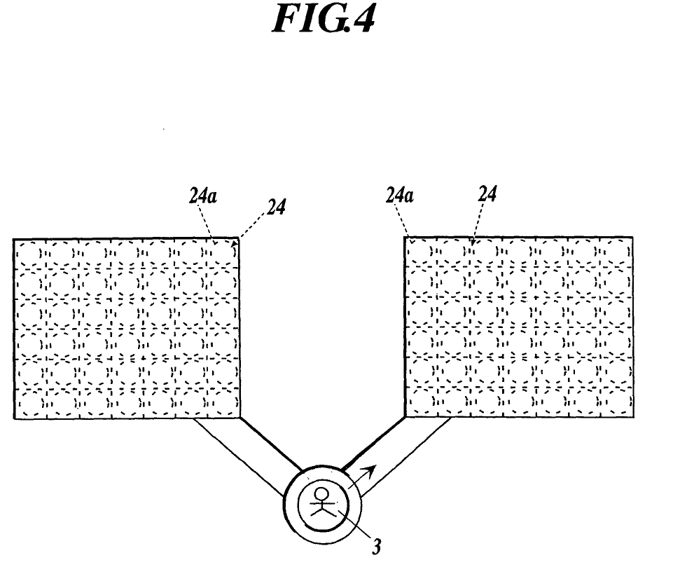

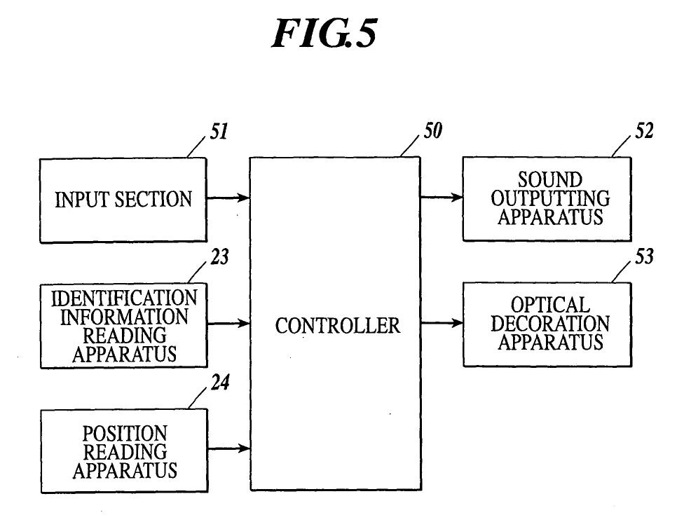

Moreover, as shown in FIG. 4 (plan view), presented under each of the concave portions 22 is a position reading apparatus 24. The position reading apparatus 24 includes coils 24a respectively arranged in each of grid portions, which are regions separated on a grid. Tops of these coils 24a are covered with sheets. Then, when the tip 3 is put or moved in the concave portion 22, there occurs an electromotive change at each of the coils 24a. A position where the tip 3 is put or moved can be detected by detecting the electromotive change or current change based on the electromotive change. Incidentally, although the electromotive change does not occur at the coils 24a if the tip 3 does not move after having been put on the concave portion 22, the position reading apparatus 24 judges that the tip 3 stays at a same position, in that case.

Incidentally, those position-reading apparatuses of any existing styles such as an apparatus including an irradiating section for irradiating infrared rays to mutually orthogonal two-ways in a field surface; and a receiving section arranged in a position facing to the irradiating section, wherein the apparatus detects a position of the tip 3 by using a block out of the infrared ray by the tip 3, an apparatus of piezoelectric style that detects tip 3 by way of weight of the tip 3, and an apparatus of other electrostatic style or the like can be used as the position reading apparatus 24.

Next, a control block of the game apparatus 100 according to the present embodiment will be described.

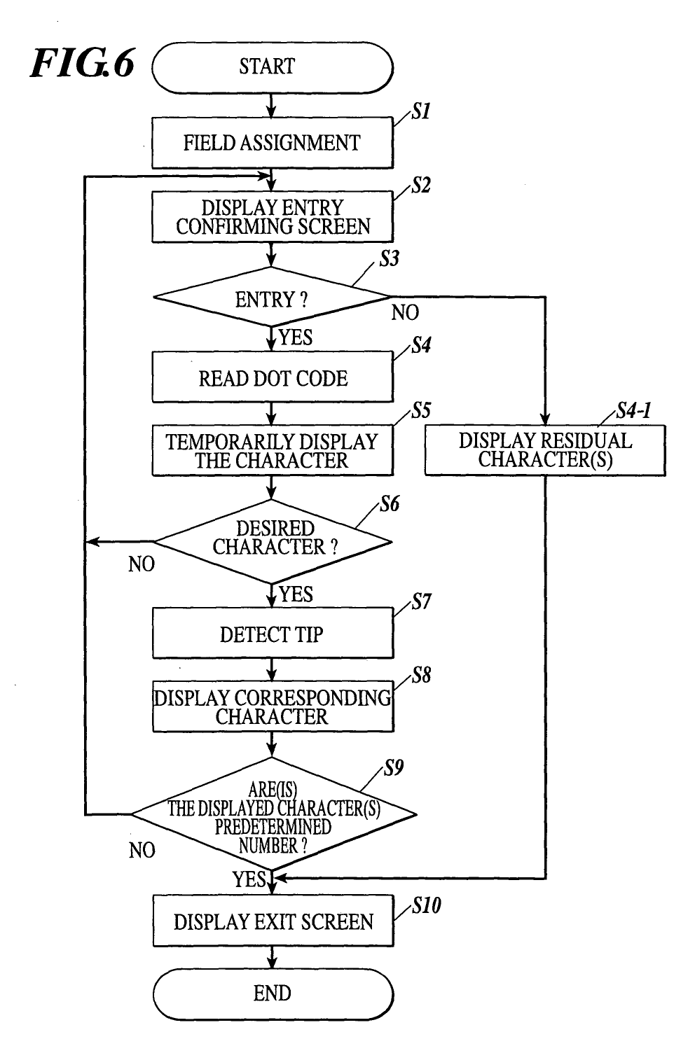

The game apparatus 100 according to the present embodiment includes, as shown in FIG. 5, a controller 50. An input section 51, the identifying information reading apparatus 23, the position reading apparatus 24, a sound outputting apparatus 52, and an optical decoration apparatus 53 are connected to the controller 100. Here, the controller 100 includes a storage section storing such as a game progression program of the game apparatus 100. Moreover, the input section 51 is composed of a switch or the like that is switched to ON/OFF associated with various buttons conducting a part of the progression of the game. Moreover, the sound outputting apparatus 52 is composed of a speaker and the optical decoration apparatus 53 is composed of a light-emitting diode (LED) or a fluorescent light or the like for decorating the game apparatus 100.

### (1) Entry Processing

Next, an example of an entry processing of a character in the game apparatus 100 according to the present embodiment will be described with reference to a flowchart shown in FIG. 6. An operation mode of the game apparatus 100 can be selected to a single player mode and a two-player mode. Therefore, the single player mode and the two-player mode will be described in this order.

### 1. In the Case of Single Player Mode

The game starts with selecting a play mode. The controller 50 causes the display screen 10 to display a selection screen for selecting the single player mode or the two-player mode. Here, if the single player mode is inputted from the input section 51, the controller 50 forcibly assigns the right field or the left field according to the game progressing program (step S1). For example, in the case of the single player mode, the controller 50 assigns the left field for the player. In this case, the controller 50 may cause the display screen 10 to display a field selection screen on the display screen 10 so that the player selects the right field or the left field from the input section 51 and the selected field may be assigned to the player.

Next, the controller 50 causes the display screen 10 to display an entry confirmation screen on the display screen 10 (step S2).

Here, if the player inputs “not entry” from the input section 51 (step S3; N), the controller 50 randomly selects characters, which will be absent in progressing the game (for example, if three characters are needed in the game, then a number of character(s) that will be absent from the game), causes the display screen 10 to display the selected character (step S4-1), causes the display screen 10 to display an exit screen (step S10), and finishes the entry process. Incidentally, when displaying the character(s) on the display screen 10, each of the characters is prevented from being overlapped with each other as a matter of course.

Meanwhile, if the player inputs “entry” from the input section 51, the process is as follows. That is, the player put a tip 3, which corresponds to a character that he/she wants to entry, on the concave portion 21. In this case, put the tip 3 so that the back surface thereof faces lower side. When the tip 3 is put on the concave portion 21, the identifying information reading apparatus 23 reads the dot code in the back of the tip 3 (step S4). After finished reading the dot code, the controller 50 stores the dot code into the storage section and causes the display screen 10 to temporarily display the character corresponding to the dot code (step S5). At the same time, the controller 50 causes the display screen 10 to display the confirmation screen for confirming whether the temporarily displayed character is a desired character or not. The temporal display in this case is for a user to confirm the character. Here, if the user refuses the character displayed on the display screen 10 (step S6; N), the process returns back to step S2. On the other hand, if the user accepts the character displayed on the display screen 10 (step S6; Y), the process proceeds to a next step S7.

Incidentally, when displaying the character(s) on the display screen 10, the controller 50 may cause the display screen 10 to display a setting screen for setting color of the character so that the user may select color of the character from the input section 51.

In step S7, when the player moves the tip 10 from the concave portion 21 to the concave portion 22 by sliding the tip along the band-like concave portion 23, the position reading apparatus 24 detects the tip 3 at a position where the tip 3 enters into the field composed of the concave portion 22. Then, the controller 50 causes the display screen 10 to display the character (have the character coming out in the screen) corresponding to the dot code as read earlier by the identification information reading apparatus 23 (step S8).

In this case, the character may be displayed on the display screen 10 only when the coil 24a, which is nearest to the band-like concave portion 23, firstly detects the tip 3 among the other coils 24a. That is, if any of the other coils 24a firstly detects the tip 3 earlier than the coil 24a nearest to the band-like concave portion 23, the detection may be treated as an error. On the other hand, the character may be displayed on the display screen 10 when any one of the coils 24a firstly detects the tip 3.

Then afterward, the character, position information of which is read by the position reading apparatus 24 and is displayed on the display screen 10, is kept to be displayed on the display screen 10 at a position corresponding to where the tip 3 is moved in the field as long as the tip 3 is not removed from the field.

When the character is displayed on the display screen 10 as described above, the controller 50 judges whether the number of character(s) reaches to a predetermined number or not. If the number of the character does not reach the predetermined number (step S9; N), the process returns back to step S2. Then, if the number of the character reaches to the predetermined number after repeating the steps (step S9; Y), the controller 50 causes the display screen 10 to display the entry exit screen (step S10) and ends the entry processing.

Incidentally, in the case of the single player mode, an opponent character may automatically be selected by the controller 50.

### 2. In the Case of Two-Player Mode

When the two-player mode is selected from the input section 51, the controller 50 automatically selects the right field or the left field to be entered first. Then, a player of the field having been selected to enter first entries a character using own field in the same manner described above. Afterward, the other player entries a character using own field in the same manner described above.

Needless to say, the procedural steps are not limited to the case described above.

### 3. In the Case of Losing the Character During the Game

There are occasions when the character disappears from the display screen 10 for the reason that, for example, the tip 3 corresponding to the character has removed from the field, though a position information is read by the position reading apparatus 24 and the character is displayed on the display screen 10. In this case, an entry processing is carried out by the above-mentioned steps of from S2 to S10. Judging whether the character has been disappeared or not can be done based on the electromotive change of the coil 24a.

### (2) Character Moving Processing

The character can be operated on the display screen 10 by moving the tip 3 during the period of time when the character displayed on the display screen 10 corresponds to the tip 3 in the field. That is, the display screen 10 is ideally also divided in a grid as the field is, and the grid portion of the display screen 10 corresponds one-to-one to that of the field. Then, when a position of the tip 3 is detected by the coil 24a located under the field, the character moves to a position corresponding to that of the tip 3.

In this case, when the tip 3 moves along a complicated trajectory on the field for each movement, the character may be moved corresponding to the trajectory. However, the character may be moved linearly corresponding to a start position and a finally stopped position of the tip 3.

Moreover, if a certain character (an automatically selected character) is automatically displayed, that is, the character does not correspond to the tip 3 on the field, there are occasions when a position where a character selected by a player is to be moved and a position where the automatically selected character is are overlapped. In such cases, the character selected by the player may be moved to a position short of the automatically selected character. Moreover, in the case that the a position where a character selected by a player is to be moved and a position where the automatically selected character is are overlapped, the both characters may be combined into one.

Incidentally, in the case of displaying a certain character automatically, the automatically selected character may be moved arbitrarily by the controller 50 when the other character selected by a player is moved.

### (3) Battle Game

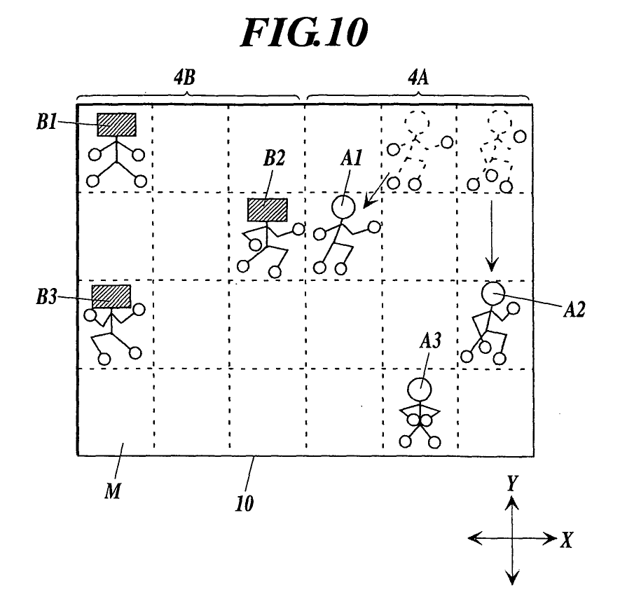

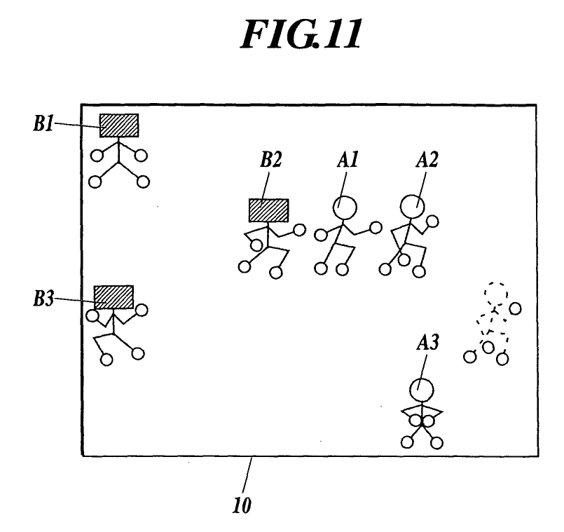

As shown in FIG. 10, the display screen 10 is divided into right and left. A friendly area 4A is set in the right side and an enemy area 4B is set in the left side. In order to simplify the explanation, each of the areas 4A and 4B is assumed to be divided on a grids M of longitudinal (for example, 4 squares) by lateral (for example, 3 squares). Player-characters A1-A3 can be moved to a two-dimensional direction of longitudinal and lateral (to an X-Y direction) by each of the grids M according to a movement order described below. Incidentally, though much the same is true on enemy-characters B1-B3, the following explanation will be described using the player-characters A1-A3 to simplify the explanation.

The figure shows, for example, the player-character A1 moves from a grid M shown by a broken line to a direction of arrow to go against the enemy-character B2, and the player-character A2 moves from a dashed position to a solid position adjacent to the player-character A3.

Incidentally, it is preferred that an attack capability and a defense capability vary corresponding to character positions. For example, a character in front has a high attack capability and a character in the back has a high defense capability, and so on. Moreover, it is preferred that each character has an attribute and damage point varies corresponding to the attribute. For example, a character having an ice attribute is weak against flame, or the like. Further, it is preferred that an attack by an other party can be dodged by moving the tip 3.

The movement of the player-character is carried out by moving the tip 3 if the character is the character selected by the player and carried out by an input from the input section 51 if the character is the automatically selected character. That is, each of the player-characters A1-A3 can be moved individually to +X direction (−X direction) and +Y direction (−Y direction) by moving the tip 3 on the field or by inputting from the input section 51.

Action selections other than the movement of the player-characters A1-A3 is input from the input section 51. Incidentally, travel distance of the automatically selected character to the X direction or the Y direction can be set from the input section 51.

It is assumed that the game progressing program stored in the storage section of the controller 50 includes an action program not only for the player-characters A1-A3 but also for the enemy-characters B1-B3, and a control encompass for the enemy-characters B1-B3 is the same as that of for the player-characters A1-A3.

### [Game Control Action]

Next, an action will be explained with taking a battle game as an example.

It is assumed that an action mode in this case is the single player mode, that is, the user (operator) operates the player-characters A1-A3 as characters of his/her own and an action of the enemy-characters B1-B3 as the opponent is automatically controlled by the controller 50 based on the action program. It is assumed that a progression of the game at this time is in a battle game mode. Incidentally, in the case of the two-player mode, one operator operates the player-characters A1-A3 and the other operator operates the enemy-characters B1-B3. Control of the enemy-characters B1-B3 can be easily understood by translating the following player-characters A1-A3 to the enemy-characters B1-B3, therefore an explanation is omitted.

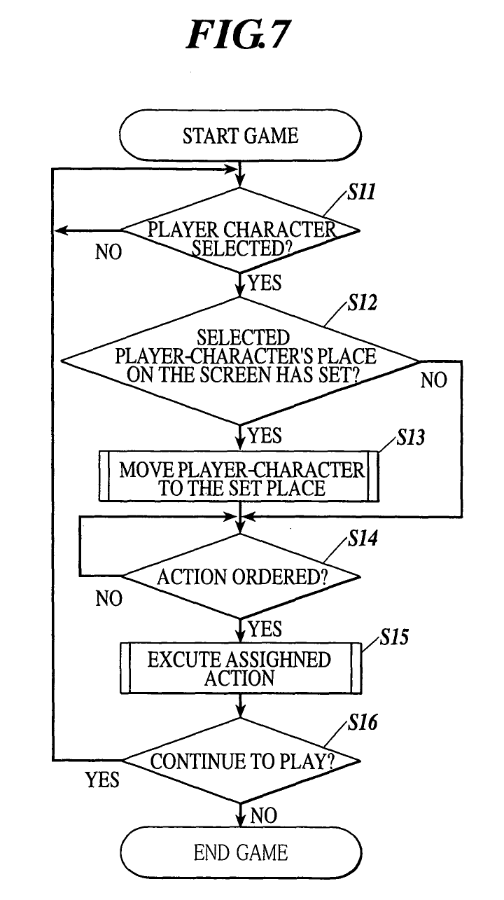

First of all, it is required to select any one of the player-characters A1-A3 at step S11 shown in FIG. 7. At this time, it is preferred, for example, to preliminarily establish priority in the player-characters A1-A3 and a high-priority player-character may be displayed with blinking. By doing so, judgment for selecting a player-character becomes easy and it is possible to make the game carry diversity. If any one of the player-characters A1-A3 are selected (step S11; Y), the process progresses to step S12.

It is confirmed whether the selected player-character's place on the display screen 10 (display position) has changed or not in step S12. If the place has set (step S12; Y), the process progresses to step S13. Setting of the place in this case is done by a movement of the tip 3 on the field if the player-character is a character selected by the player, by an input from the input section 51 if the player-character is the automatically selected character, and by the controller 50 according to the game progressing program if the character is the enemy-character.

In step S13, the player-character selected in step S11 is moved to the set place.

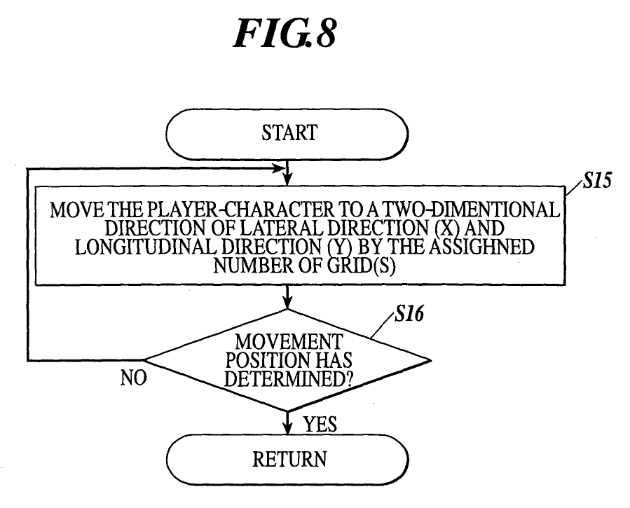

The movement is set freely in the two-dimensional direction of lateral (X)-longitudinal (Y) direction as indicated in step 31 shown in FIG. 8. If the place has determined, the process returns back to a master routine in FIG. 7. See FIG. 10 for an example embodiment of the movement.

Meanwhile, in step S12, if the selected player-character's place is not set (step 12; N), the process jumps to step S14.

In step S14, it is judged whether an action order with respect to the selected player-character exists or not. If there are no action orders (step S14; N), the process becomes standby condition. If there exists an action order (step S14; Y), the process progresses to step S15.

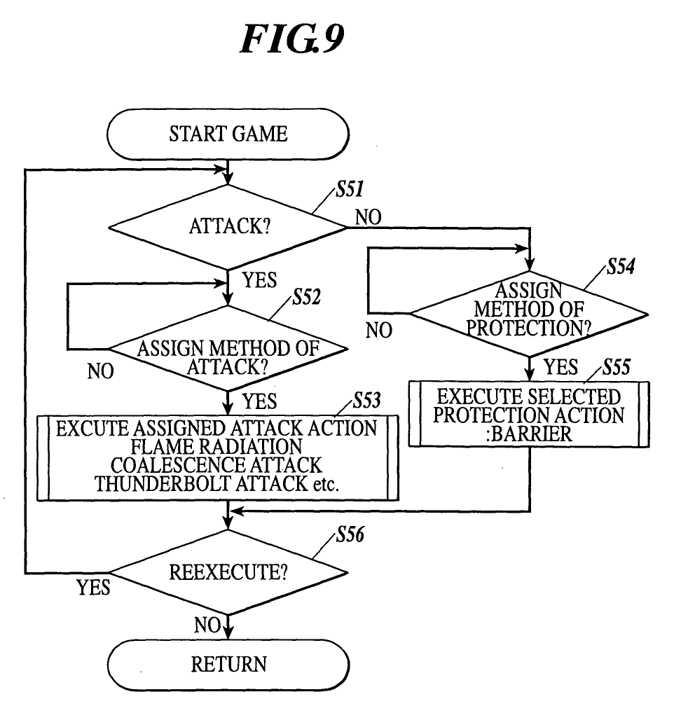

In step S15, the controller 50 executes an action corresponding to the order. A subroutine of the step S15 is shown in FIG. 9. In this subroutine, the controller 50 firstly judges whether the action order is an attack order or not in step S51. As a result, if the action order is the “attack order” (step S51; Y), the process progresses to step S52, and a method of attack is confirmed. If a method of attack is assigned (step S52; Y), attack for the enemy-characters B1-B3 is executed by a method of attack to be selected in step S53.

For example, a “flame radiation”, a “coalescence attack”, a “thunderbolt attack”, or the like are recited as the method of attack (content of an attack representation displayed on the display screen).

The flame radiation attack is effective since a single flame radiation can attack many enemy-characters all together when a plurality of enemy-characters are mutually arranged in close position.

Moreover, in the case of the coalescence attack, the content of an attack representation (displayed on the display screen) against the enemy-characters B1-B3 varies corresponding to a comparative positional relationship among the friendly player-characters A1-A3. For example, as shown in FIG. 11, by moving the friendly player-character A2 to a position behind A1 to approximate characters on the same side can set more powerful attack capability. In this case, however, it is likely that the friendly player-characters are easy to be damaged by simultaneous attacks (i.e. the aforementioned flame radiation, or the like) by the enemy-character to the contrary.

The thunderbolt attack is also effective when a plurality of enemy-characters are in a comparative positional relationship such as mutually arranged in close position. That is, when the plurality of enemy-characters B1-B3 are displayed in mutually approximate positions, actions of at least two or more enemy-characters can be controlled simultaneously and comprehensively or can be stopped (meaning disappearance or the like by damage).

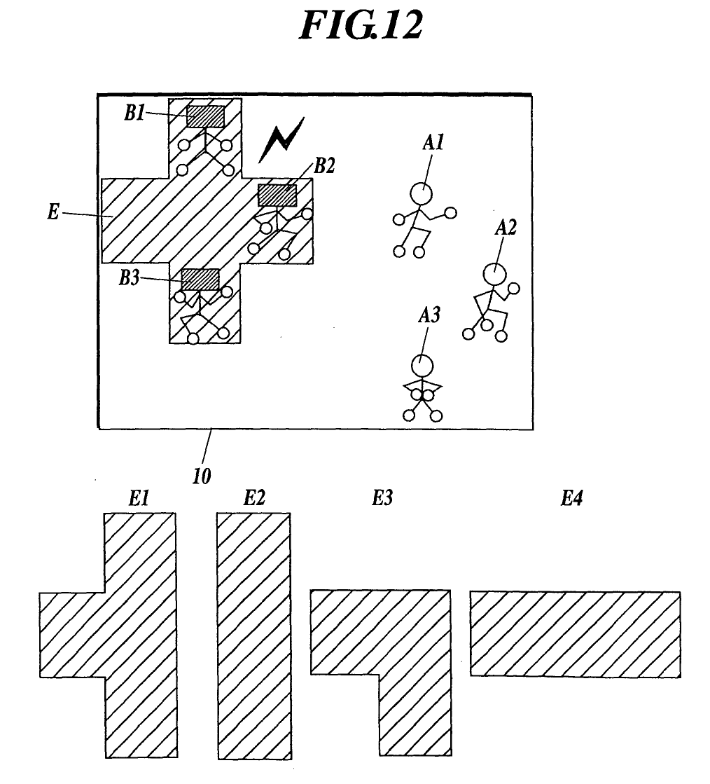

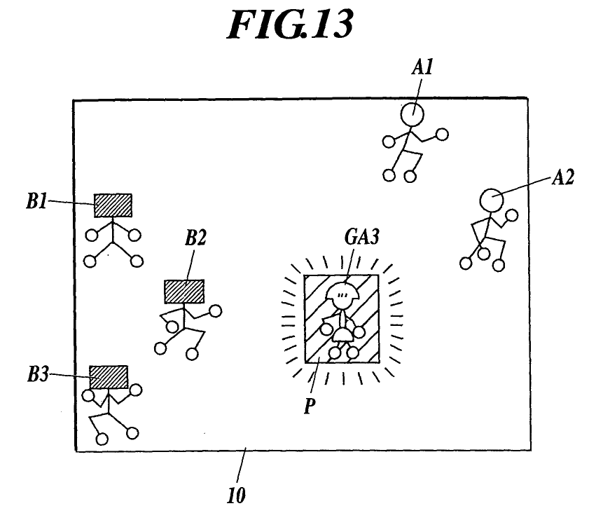

An exemplary image of the thunderbolt attack is shown in FIG. 12. A basic shape of an area of the thunderbolt is a crisscross corresponding to the grids M, and the area varies based on proximity to a boundary between the friendly area 4A and the enemy-area 4B or varies based on a longitudinal direction (Y). Exemplary variances are shown in thunderbolt areas E1-E4 and the like in FIG. 9.

Here, return again back to step S51, if a judging result is not the attack order, the controller 50 judges that the action order is a “protection order” and the process progresses to step S54. In step S54, it is judged whether a method of protection is assigned or not. If the method is assigned (step S54; Y), the protection will be executed in step S55. As an exemplary method of protection, for example, shown in FIG. 13, cover the friendly player-character (female) GA3 with barrier P so that an attack by the enemy-character does not work.

After finishing the execution of an attack in step S53 or a protection in step S54, the process progresses to step S56 and the controller 50 judges whether the attack or protection should be reexecuted or not. If the attack or protection should be reexecuted, the process returns back to step S51 and the actions as mentioned above will be repeated. If the attack or protection is not reexecuted, the process returns back to the master routine.

Here, return back to FIG. 7, in step S16, the controller 50 confirms whether the game should be continued or not. If the game should be continued, actions, which are the same as after the above-mentioned step S11 are executed. If the game should not be continued (step S16; N), then, the game ends.

### INDUSTRIAL APPLICABILITY

As described above, the game apparatus according to the present invention is useful for downsizing the reading apparatus and reading or analyzing data in a short time compared with the conventional products.

### REFERENCE SIGNS LIST

100 game apparatus
1 upper structure
2 lower structure
3 tip
20 table
21 concave portion (reader)
22 concave portion (field)

What is claimed is:

1. A game apparatus, comprising:
a figurative object having character identifying information;
a reading area for reading the character identifying information;
a field where the figurative object is moved freely;
a storage section for storing a plurality of display character identifying information to correspond to a plurality of the character identifying information, respectively;
an identifying information reading section for reading the character identifying information from the figurative object at the reading area;
a position detecting section for detecting a position of the figurative object on the field;
a display for displaying a character corresponding to the read character identifying information based on the display character identifying information; and
a controller for controlling a position of the character on the display, wherein
when the figurative object is put on the field at a first time after the character identifying information has been read by the identifying information reading section, the controller causes the display to display the character corresponding to the read character identifying information and controls the position of the character based on a detected result of the position of the figurative object on the position detecting section.

2. The game apparatus according to claim 1, wherein
the figurative object includes a dot code as the character identifying information.

3. The game apparatus according to claim 1, wherein
the identifying information detecting section is composed of an optical reader.

4. The game apparatus according to claim 1, wherein
the figurative object includes a metal section; and
the position detecting section includes a plurality of coils positioned under the field and detects the position of the figurative object based on an electromotive change produced at the coils according to movement of the figurative object.
